(19) United States
(12) Patent Application Publication
(10) Pub. No.: US 2015/0239231 A1
(43) Pub. Date: Aug. 27, 2015

(54) METHOD FOR REDUCING ARTIFACTS USING TENSION CONTROL

(71) Applicant: Eastman Kodak Company, Rochester, NY (US)

(72) Inventors: Matthias Hermann Regelsberger, Rochester, NY (US); Randy Eugene Armbruster, Rochester, NY (US)

(21) Appl. No.: 14/191,489

(22) Filed: Feb. 27, 2014

(51) Int. Cl. B41F 21/00

(52) U.S. Cl. CPC B41F 21/00

(57) ABSTRACT

A method for using tension control adjustments on a web to reduce registration errors while printing multiple copies of a print job on the web comprises providing a printing system with a print station one or more rollers adapted to receive tension control commands. The tension control commands operate on the rollers to control the amount of tension in the web. The printing system is used to print a first copy of the print job. A plurality of registration errors produced during the printing of the first copy of the print job is determined. First tension control adjustments based on the plurality of registration errors are used to adjust the tension control commands to the rollers in the printing system for printing a second copy of the print job, thereby reducing registration errors.

### CROSS REFERENCE TO RELATED APPLICATIONS

Reference is made to commonly-assigned, U.S. patent application Ser. No. ______ (Docket K001671), entitled “SYSTEM FOR REDUCING ARTIFACTS USING TENSION CONTROL”, Ser. No. ______ (Docket K001672), entitled “METHOD FOR REDUCING TENSION FLUCTUATIONS ON A WEB”, Ser. No. ______ (Docket K001673), entitled “SYSTEM FOR REDUCING TENSION FLUCTUATIONS ON A WEB”, all filed concurrently herewith.

### FIELD OF THE INVENTION

The present invention generally relates to printing apparatus for web of print media and more particularly to controlling tension of web of print media in a printing system to reduce printing artifacts such as color-to-color registration and stabilize tension fluctuations of the web of print media.

### BACKGROUND OF THE INVENTION

Continuous web printing permits economical, high-speed, high-volume print reproduction. In this type of printing, a continuous web of paper or other substrate material is fed past one or more printing subsystems that form images by applying one or more colorants onto the substrate surface. In a conventional web-fed rotary press, for example, a web substrate is fed through one or more impression cylinders that perform contact printing, transferring ink from an imaging roller onto the web in a continuous manner.

Proper registration of the substrate to the printing device is of considerable importance in applications such as print reproduction, particularly where multiple colors are used in printing color images. Similarly, in the printing of electrical circuits, proper registration is critical in the deposition of electrically conductive or insulating layers in forming a multi-layer electrical circuit such as touch panels. Conventional web transport systems in today's commercial offset printers address the problem of web registration with high-precision alignment of machine elements. Typical of conventional web handling subsystems are heavy frame structures, precision-designed components, and complex and costly alignment procedures for precisely adjusting substrate transport between components and subsystems.

Alignment during actual print production is aided by vision systems monitoring the printed output in real time, comparing the output with a reference image and displaying the information to the operator to consider taking corrective actions. Such vision systems can monitor the color reproduction or the registration or both aspects of the print production to ensure the desired output quality.

The problem of maintaining precise and repeatable web registration and transport becomes even more acute with the development of high-resolution non-contact printing, such as high-volume inkjet printing. With this type of printing system, finely controlled dots of ink are rapidly and accurately propelled from a print station onto the surface of the moving media, with the web substrate often coursing past the print station at speeds measured in hundreds of feet per minute. No impression roller is used; synchronization and timing are employed to determine the exact timing of the sequential deposition of ink by different print stations onto the moving media. The requirements for the printed output are driven by intended use and function of the printed product. For any multi-step printing process, the image quality attributes always include registration, print resolution and the reduction of print artifacts. Other attributes, specific to the output can be added, for example color reproduction for graphic arts printing. With dot resolution of 600 dots-per-inch (DPI) and better, a high degree of registration accuracy can be achieved theoretically, limited only by the digital resolution inherent in the digital print station. During printing, variable amounts of ink is applied to different portions of the rapidly moving web, with drying mechanisms typically employed after each print station or bank of print stations. Variability in ink or other liquid amounts and types and in drying time can cause substrate stiffness and tension characteristics to vary dynamically over a range for different types of substrate, contributing to the overall complexity of the substrate handling and registration challenge.

One approach to the registration problem is to provide a print module that forces the web of print media along a tightly controlled print path. This is the approach that is exemplified in U.S. Patent Publication No. 2009/0122126, entitled “Web Flow Path” by Ray et al. In such a system, there are multiple drive rollers that fix and constrain the web of print media position as it moves past one or more print stations.

Problems with such a conventional approach include significant cost in design, assembly, adjustment, and alignment of web handling components along the media path. While such a conventional approach permits some degree of modularity, it would be difficult and costly to expand or modify a system with this type of design. Each “module” for such a system would itself be a complete printing apparatus, or would require a complete, self-contained subassembly for paper transport, making it costly to modify or extend a printing operation, such as to add one or more additional colors or processing steps, for example.

Various approaches to web tracking are suitable for various printing technologies. For example, active alignment steering, as taught for an electrographic reproduction web (often referred to as a belt on which images are transported) in commonly assigned U.S. Pat. No. 4,572,417 entitled “Web Tracking Apparatus” to Joseph et al. would require multiple steering stations for continuous web printing, with accompanying synchronization control. It would be difficult and costly to employ such a solution with a print medium whose stiffness and tension vary during printing, as described above. Other solutions for web (or belt as referred to above) steering are similarly intended for endless webs in electro-photographic equipment but are not readily adaptable for use with paper media. Steering using a surface-contacting roller, useful for low-speed photographic printers and taught in commonly assigned U.S. Pat. No. 4,795,070 entitled “Web Tracking Apparatus” to Blanding et al. would be inappropriate for a surface that is variably wetted with ink and would also tend to introduce non-uniform tension in the cross-track direction. Other solutions taught for photographic media, such as those disclosed in commonly assigned U.S. Pat. No. 4,901,903 entitled “Web Guiding Apparatus” to Blanding are well suited to photographic media moving at slow to moderate speeds but are inappropriate for systems that need to accommodate a wide range of media, each with different characteristics, and transport each media type at speeds of hundreds of feet per minute.

In order for high-speed non-contact printers to compete against earlier types of devices in the commercial printing market, the high cost of the web transport should be greatly reduced. There is a need for an adaptable non-contact printing system that can be fabricated and configured without the cost of significant down-time, complex adjustment, and constraint on web of print media materials and types.

One aspect of such a system relates to components that feed the continuous web substrate into the printing system and guide the web of print media into a suitable cross-track position for subsequent transport and printing. This problem is exacerbated by the shrinking and expanding of web of print media due to wetting and drying. The change in the structure of the web of print media results in color-to-color registration errors during printing.

In other applications such as the manufacture of touch screens, the web of print media is typically made of plastic with a solvent based ink used in the printing process. Drying at elevated temperatures will change the dimensions of the support during the printing process much like in conventional printing applications.

In commercial inkjet printing systems, the web of print media is physically transported through the printing system at a high rate of speed. For example, the web of print media can travel 650 to 1000 feet per minute. The print stations in commercial inkjet printing systems typically include multiple jetting modules that jet ink onto the web of print media as the web of print media is being physically moved through the printing system. A reservoir containing ink or some other material is typically behind each nozzle plate in a print station. The ink streams through the nozzles in the nozzle plates when the reservoirs are pressurized.

The jetting modules in each print station in commercial printing systems typically jet only one color. In printing systems designed to manufacture electrical circuits, the jetting modules in each print station jet only electrically conductive inks, electrically insulating inks or inks to form protective coatings for the circuit. In printing systems designed for commercial printing or system designed to manufacture electrical circuits, the sequential deposition of inks along the conveyance path of the print media will form the printed product. The quality requirements and attributes of the printed product are derived from the use and application of the printed product. For example, in commercial printing systems the registration of the four colors forming the color image has to be performed precisely, the printed image should not have image artifacts and the overall color reproduction should resemble closely the color of the original object. In the manufacture of electrical circuits, the registration of the insulating and conductive layers should be performed precisely to avoid electrical short circuits. There should be no image artifacts such as voids affecting the electrical traces, making them non-conductive. Similarly, the crossing of two conductors not properly insulated from each other should be avoided. The current carrying capacity of each trace can require a certain density of conductive ink. For each of the example applications, the ink is jetted sequentially and deposited on the moving print media web as it is conveyed passed multiple print stations. In the examples, the printed output is composed of multiple layers, also referred to as separations, which should be aligned to each other to produce a single color impression for the observer of the commercial print or the desired function selected by the user on the touch screen panel forming the user interface.

The mis-alignment of layers or separations of a multi-layer print is typically referred to as registration error. Registration errors are partitioned into different types. Examples of registration errors include, but are not limited to, a separation having a linear translation with respect to another separation, a separation being rotated with respect to another separation, and a separation being stretched, contracted, or both stretched and contracted with respect to another separation. There are several variables that contribute to the registration errors in separation alignment including physical properties of the web of print media, conveyance of web of print media, ink application system, ink coverage, and drying of ink. Registration errors can be reduced by controlling these variables.

There is, then, a need for a tension control system that can reduce registration errors by controlling the conveyance of the web of print media in a high-speed commercial printing system for non-contact printing applications and compensate for varying tensions in the receiver web due to modulus changes of the material such as paper or plastic due to the sequential inking and drying steps employed to form the final image on the receiver web.

### SUMMARY OF THE INVENTION

The present invention is directed to systems and methods for controlling tension in a web of print media to reduce registration errors and tension fluctuations in a printing system.

According to an aspect of the present invention, a method for using tension control adjustments on a web to reduce registration errors while printing multiple copies of a print job on the web, comprises:

providing a printing system with a print station disposed opposite a first side of the web, the print station defining one or more print zones where a liquid is deposited onto the first side of the web, and first one or more rollers adapted to receive tension control commands, the tension control commands operating on the first rollers to control the amount of tension of the web in the printing system;

using the printing system to print a first copy of the print job on the web;

determining a plurality of registration errors produced during the printing of the first copy of the print job;

using a processor to determine first tension control adjustments based on the plurality of registration errors; and

using the first tension control adjustments to adjust the tension control commands to the first one or more rollers in the printing system for printing a second copy of the print job, thereby reducing registration errors.

The methods and systems of the present invention provide several significant advantages. Controlling the tension in the web in the printing system permits the system to have fewer constraints. The printing system can be made in a modular manner, adding or removing print stations without the need for expensive alignment and registration of various transport and constraint rollers. The web can be self-aligned, permitting a simpler organization of the components of the printing system. Wetting of the web due to ink laydown, and subsequent drying, can expand or shrink the web, resulting in registration errors between successive printing on the same portion of the web. The present invention provides methods and systems for using tension control in the web to reduce registration errors due to deformations of the web. Further, deformations in the web can cause a change in the tension in the web, resulting in the formation of folds or wrinkles in the web. The tension control adjustments can be used to stabilize tension fluctuations in the web due to deformations from wetting and drying, resulting in a reduction in the formation of folds and wrinkles in the web.

Controlling the tension in the web limits flutter or the up-and-down movement of the web in the printing system, permitting a position sensing system, such as a vision system to more precisely measure the position of the registration or alignment marks on the web.

### BRIEF DESCRIPTION OF THE DRAWINGS

In the detailed description of the preferred embodiments of the invention presented below, reference is made to the accompanying drawings, in which:

FIG. 1 is a schematic side view of a digital printing system according to an aspect of the present invention;

FIG. 2 is an enlarged schematic side view of media transport components of the digital printing system shown in FIG. 1;

FIG. 3 is a top view showing the arrangement of rollers and surfaces within the turnbar module in as aspect of the invention without including the support structure;

FIG. 4 is an isometric view showing the arrangement of rollers and surfaces within the turnbar module in an aspect of the invention without including the support structure;

FIG. 5 is a schematic side view of a large-scale two-sided digital printing system according to another aspect of the present invention;

FIG. 6a shows the configuration of the out feed module of printing system in FIG. 5;

FIG. 6b shows an alternate configuration of the out feed module of printing system in FIG. 5;

FIG. 7 shows a flowchart for a method for reducing registration errors according to an aspect of the present invention;

FIG. 8 shows a flowchart for a method for reducing registration errors according to another aspect of the present invention;

FIG. 9a shows examples of registration errors in the in-track direction according to an aspect of the present invention;

FIG. 9b shows examples of registration errors in the cross-track direction according to an aspect of the present invention;

FIG. 10 shows a flowchart for a method for reducing registration errors according to an aspect of the present invention; and

FIG. 11 shows a flowchart for a method for reducing registration errors according to another aspect of the present invention.

### DETAILED DESCRIPTION OF THE INVENTION

The present description will be directed in particular to elements forming part of, or cooperating more directly with, apparatus in accordance with the present invention. It is to be understood that elements not specifically shown or described can take various forms well known to those skilled in the art.

The method and system of the present invention provide a modular approach to the design of a digital printing system, utilizing features and principles of exact constraint for transporting a continuously moving web of print media past one or more digital print stations. The system and method of the present invention are particularly well suited for printing systems that provide non-contact application of water-based or solvent-based inks onto a continuously moving medium for the purpose of producing, for example, multi-color prints on paper or for the manufacture of multi-layered electrical circuits on plastic foil. The print station of the present invention image-wise applies inks to at least some portion of the web of print media as it courses through the printing system, but without the need to make contact with the web of print media. The terms web of print media, web, and print media are used interchangeably in the disclosure and are understood to refer to a continuous web of print media.

In the context of the present disclosure, the term “continuous web of print media” relates to a print media that is in the form of a continuous strip of media as it passes through the printing system from an entrance to an exit thereof. The continuous web of print media itself serves as the receiving print medium to which one or more printing ink or inks or other coating liquids are applied in non-contact fashion. This is distinguished from various types of “continuous webs” or “belts” that are actually transport system components rather than receiving print media and that are typically used to transport a cut sheet medium in an electro-photographic or other printing system. The terms “upstream” and “downstream” are terms of art referring to relative positions along the transport path of a moving web; points on the web move from upstream to downstream. Where they are used, the terms “first”, “second”, and so on, do not necessarily denote any ordinal or priority relation, but are simply used to more clearly distinguish one element from another.

Kinematic web handling is provided not only within each module of the system of the present invention, but also at the interconnections between modules, as the continuously moving web medium passes from one module to another. Unlike a number of conventional continuous web imaging systems, the apparatus of the present invention does not require a slack loop between modules, but can use a slack loop only for print media that has been just removed from the supply roll at the input end. Removing the need for a slack loop between modules or within a module permits addition of a module at any position along the continuously moving web, taking advantage of the self-positioning and self-correcting design of print media path components.

The system and methods of the present invention adapt a number of exact constraint principles to the problem of web handling. As part of this adaptation, disclosed are ways to permit the moving web to maintain proper cross-track registration in a “passive” manner, with a measure of self-correction for web alignment. Steering of the web is avoided unless absolutely necessary; instead, the web's lateral and angular positions in the plane of transport are exactly constrained. Moreover, other web support devices used in transporting the web, other than non-rotating surfaces or those devices purposefully used to exactly constrain the web, are permitted to self-align with the web. The digital printing system according to this invention includes one or more modules having rollers that guide the web of print media as it passes at least one non-contact digital print station. The digital printing system can also include components for drying or curing of the printing fluid on the print media; for inspection of the print media, for example, to monitor and control print quality; and various other functions. The digital printing system receives the print media from a media source, and after acting on the print media conveys it to a media receiving unit. The print media is maintained under tension as it passes through the digital printing system, but it is not under tension as it is received from the media source.

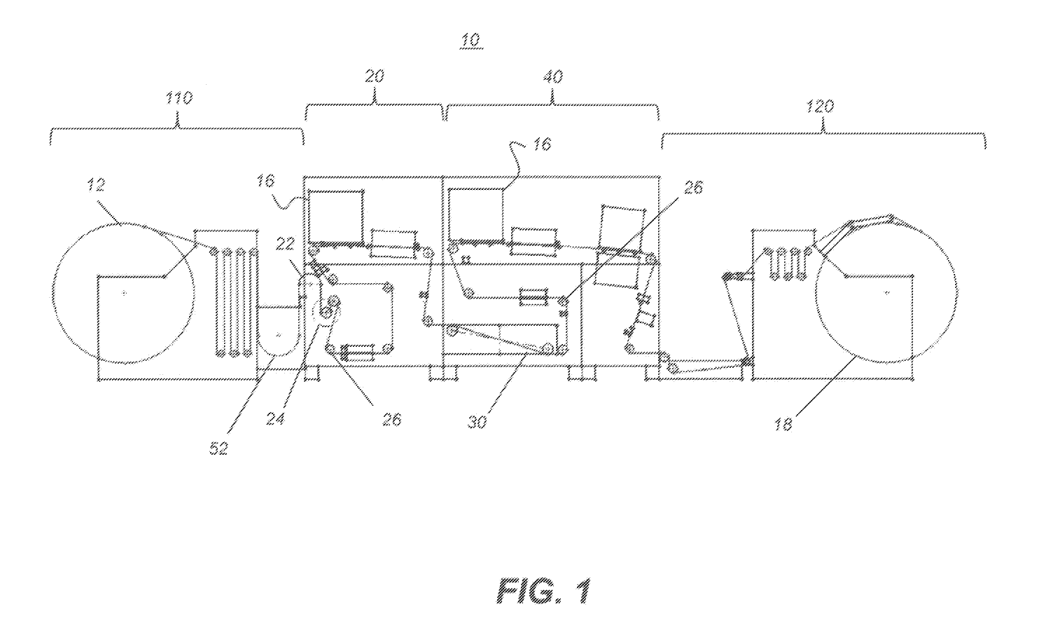

Referring to the schematic side view of FIG. 1, there is shown a digital printing system 10 for continuous web printing according to an aspect of the present invention. A first module 20 and a second module 40 are provided for printing on continuous web of print media that originates from a source roller 12. Following an initial slack loop 52, the print media that is fed from source roller 12 is then directed through digital printing system 10, past one or more digital print stations 16 and supporting printing system 10 components. The print stations 16 define print zones 54 in the printing system where ink or other liquid is jetted onto the print media. First module 20 has a support structure that includes a cross-track positioning mechanism 22 for positioning the continuously moving web of print media in the cross-track direction, that is, orthogonal to the direction of travel and in the plane of travel. In one aspect of the present invention, cross-track positioning mechanism 22 is an edge guide for registering an edge of the moving print media. A tensioning mechanism 24, affixed to the support structure of first module 20, includes structure that sets the tension of the print media.

Downstream from first module 20, along the path of the continuous web of print media, second module 40 also has a support structure, similar to the support structure for first module 20. Affixed to the support structure of either or both the first or second module 20 or 40 is a kinematic connection mechanism that maintains the kinematic dynamics of the continuous web of print media in traveling from the first module 20 into the second module 40. Also affixed to the support structure of either the first or second module 20 or 40 are one or more angular constraint structures 26 for setting an angular trajectory of the web of print media.

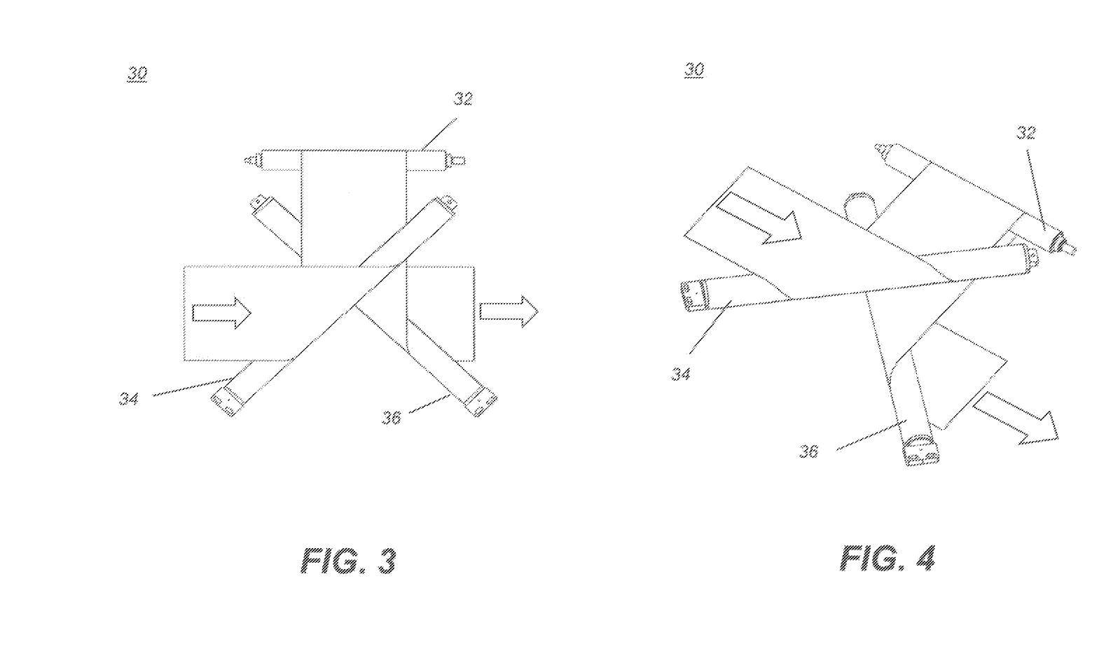

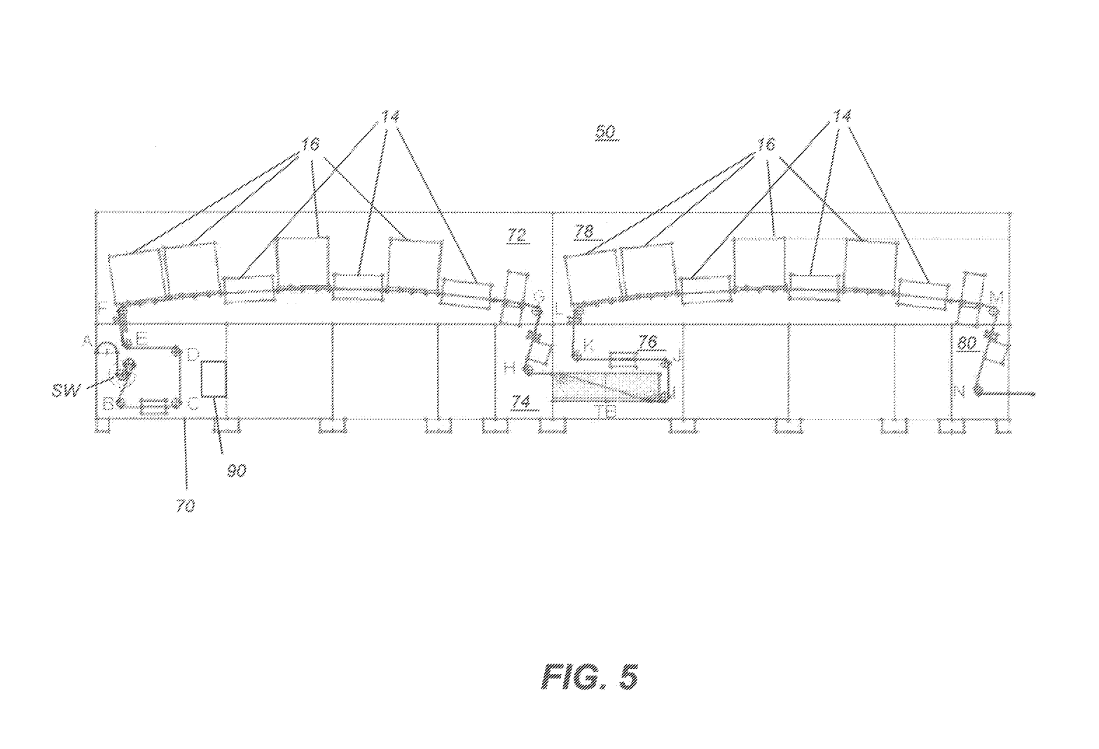

Still referring to FIG. 1, printing system 10 optionally also includes a turnbar module 30 that is configured to turn the print media over, flipping it backside-up in order to print on the reverse side. The web path and roller placement within turnbar (TB) module 30 is shown in FIGS. 3 and 4 and is discussed below in further detail. The print media then leaves the digital printing system 10 and travels to a media receiving unit, in this case a take-up roll 18. A take-up roll 18 is then formed, rewound from the printed web of print media. The digital printing system can include a number of other components, including multiple print heads and dryers, for example, as described in more detail subsequently. Other examples of system components include web cleaners, web tension sensors, and quality control sensors.

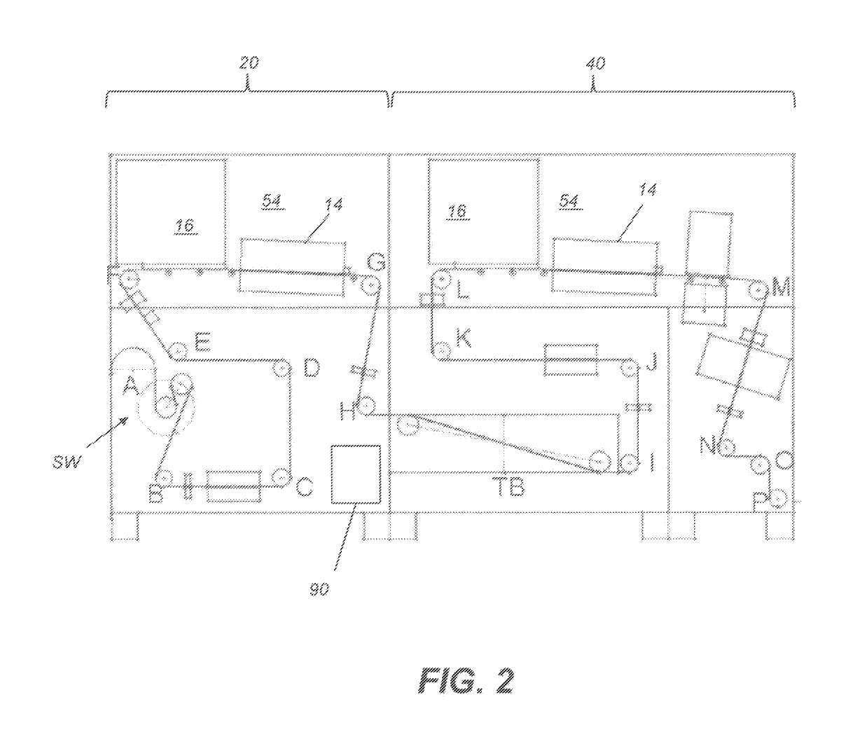

The schematic side view diagram of FIG. 2 shows, at enlarged scale from that of FIG. 1, the media routing path through modules 20 and 40 according to one aspect of the present invention. Within each module 20 and 40, in a print zone 54, each print station 16 is followed by a dryer 14.

Table 1 that follows identifies the lettered components used for web of print media transport and shown in FIG. 2. An edge guide in which the print media is pushed laterally so that an edge of the print media contacts a stop is provided at A. The slack web entering the edge guide permits the print media to be shifted laterally without interference and without being overconstrained. An S-wrap device SW provides stationary curved surfaces over which the continuous web slides during transport. As the web is pulled over these surfaces, the friction of the web across these surfaces produces tension in the print media. In one aspect of the present invention, the S-wrap device permits for an adjustment of the positional relationship between surfaces to control the angle of wrap and to permit adjustment of web tension.

In Table 1, two separate modules are identified, according to an aspect of the present invention. Module #1 stretches from infeed drive roller B to Turnbar (TB) containing the main drive roller. This module is equipped with a web tension sensing sensor on roller D. Module #2 stretches from Turnbar (TB) containing the main drive motor to outfeed drive roller N. Module #2 is equipped with a web tension sensing sensor on roller J. In order to enable stable tension control within these modules, the input equipment is separated by a festoon (integrated into the unwinder) and a slack loop as shown in FIG. 1 or other device to isolate variations in tension from the supply roller. Similarly, on the output side, a similar arrangement is used to isolate the variations in tension within the printing equipment from variations in tensions of the finishing equipment.

TABLE 1
Roller Listing for FIG. 2

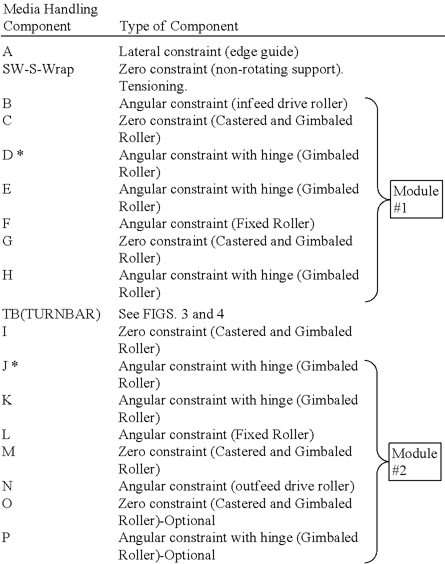

Note:
Asterisk (*) indicates locations of load cells.

The first angular constraint is provided by infeed drive roller B. This can be a fixed roller that cooperates with a drive roller in the turnbar module and with an outfeed drive roller N in second module 40 in order to move the web through the printing system with suitable tension in the movement direction (in-track direction). The tension provided by the preceding S-wrap device serves to hold the web against the infeed drive roller so that a nip roller is not required at the drive roller. Angular constraints at subsequent locations downstream along the web are often provided by rollers that are gimbaled so as not to impose an angular constraint on the next downstream web span.

In this aspect of the invention, the angular orientation of the print media in the print zone containing one or more print stations and one or more dryers is controlled by a roller placed immediately before or immediately after the print zone. This is desirable for ensuring registration of the print from multiple print stations. It is also desirable that the web not be over-constrained in the print zone. This is done by placing a constraint relieving roller such as a castered roller following the print zone or a gimbaled roller preceding the print zone. To maintain control of the transit time of the print drops from the jetting module to the print media, variations in spacing of the print station to the print media from one side of the print station to the other need to be controlled, and it is desirable to orient the printheads parallel to the print media. To maintain the uniformity of this spacing between the print station and the print media, preferably, the constraint relieving roller placed at one end of the print zone is not free to pivot in a manner that will alter the print station to print media spacing. Therefore a gimbaled roller preceding the print zone should not have a caster pivot as well. Similarly, the castered roller following the print zone should preferably not include a gimbal pivot. The use of nonrotating supports (brushbars) under the print media to support the print media in the print zone can be used to maintain proper spacing between the print media and the printheads in the print zones.

The top view of FIG. 3 and the isometric view of FIG. 4 show the arrangement of rollers for turnbar module (TB) 30, shown as part of second module 40 (in FIGS. 1 and 2). Turnbar module TB can optionally be configured as a separate module, with its own web of print media handling compatible with that of second module 40. The position of turnbar module TB is appropriately between print zones 54 for opposite sides of the print media. Here, a fixed drive roller 32 of this device provides the single angular constraint. Lateral constraint is provided by the position of the moving web upstream of stationary turnbar 34. Stationary turnbars 34 and 36 are positioned at diagonals to that the input and output paths and impart no constraint on the web as it slides over them.

The system of the present invention is adaptable for a printing system of variable size and permits straightforward reconfiguration of the system without requiring precise adjustment and alignment of rollers and related hardware when modules are combined. The use of exact constraint mechanisms means that rollers can be mounted within the equipment frame or structure using a reasonable amount of care in mechanical placement and seating within the frame, but without the need to individually align and adjust each roller along the path, as would be necessary when using conventional paper guidance mechanisms. That is, roller alignment with respect to either the media path or another roller located upstream or downstream is not required.

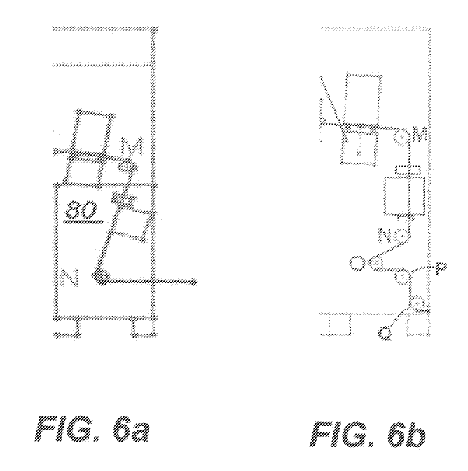

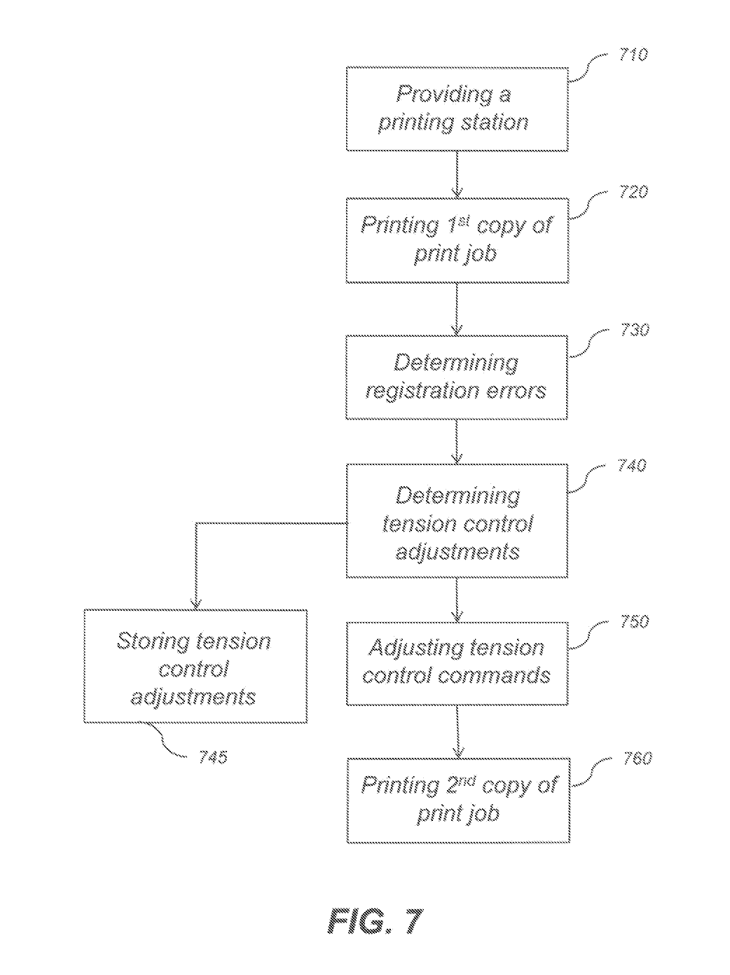

A digital printing system 50 shown schematically in FIG. 5 has a considerably longer print path than that shown in FIG. 2, but provides the same overall sequence of angular constraints, with the same overall series of gimbaled, castered, and fixed rollers. Table 2 lists the roller arrangement used with the system of FIG. 5 according to one aspect of the present invention. Brush bars between rollers F and G and between L and M in FIG. 5, are non-rotating surfaces and thus apply no lateral or angular constraint forces.

TABLE 2
Roller Listing for FIG. 5

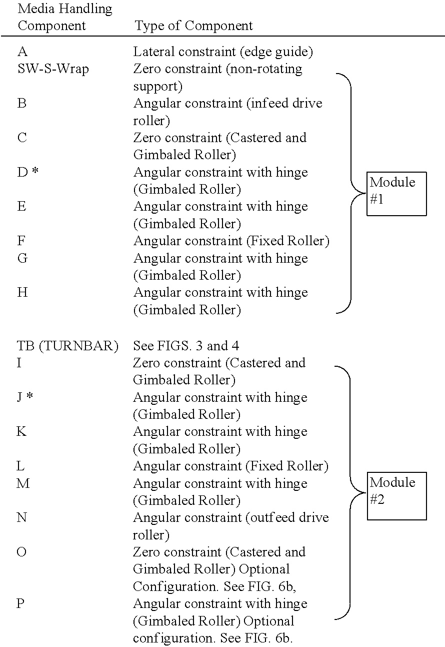

Note:
Asterisk (*) indicates locations of load cells.

In this aspect of the present invention, load cells are provided in order to sense web tension at one or more points in the system. For example, load cells can be provided at gimbaled rollers D and J. Control logic for the respective digital printing system 50 monitors load cell signals at each location and, in response, makes any needed adjustments in motor torque in order to maintain the proper level of tension throughout the system. For the aspects shown in FIGS. 2 and 5, the pacing drive component of the printing system is the turnbar module TB. In these aspects, there are two tension-setting mechanisms, one preceding and one following turnbar module TB. On the input side, load cell signals at roller D indicate tension of the web preceding turnbar module TB; similarly, load cell signals at roller J indicate web tension on the output side, between turnbar module TB and take-up roll 18. Control logic for the appropriate in- and outfeed driver rollers at B and N, respectively, can be provided by an external computer or processor connected to the printing system 50. Optionally, an on-board control logic processor 90, such as a dedicated microprocessor or other logic circuit as shown in FIGS. 2 and 5, can be provided for maintaining control of web tension within each tension-setting mechanism and for controlling other machine operations and operator interface functions. The external computer, or the on-board control logic processor 90 can be connected to memory or storage.

As described, the tension in a module preceding the turn bar and a module following the turnbar module TB can be independently controlled relative to each other further enhancing the flexibility of the printing system. In the example aspects shown in FIGS. 2 and 5, the drive motor is connected to roller 32 and included in the turnbar module TB as shown in FIGS. 3 and 4. In other aspects of the present invention, the drive motor need not be included in a turnbar module. Instead, the drive motor can be appropriately located along the web path so that tension within one module is independently controlled relative to tension in another module.

There are a number of ways to track web position in order to locate and position inkjet dots or other registration or alignment marks that are made on the print media. A variety of encoding and image-sensing devices can be used for this purpose along with the required timing and synchronization logic, provided by control logic processor 90 or by some other dedicated internal or external processor or computer workstation. Such encoders are typically placed just upstream of the print zone, and are preferably placed on a fixed roller so as to avoid interfering with the self aligning characteristics of castered or gimbaled rollers. The image-sensing devices are typically placed downstream of the print zone, capturing images of inkjet-dots or registration and alignment marks printed on the web.

Commonly-assigned U.S. Patent Publication No. 2013/0286071 by Armbruster et al., which is herein incorporated by reference in its entirety, discloses a method for performing color-to-color correction while printing multiple copies of a print job having one or more documents where the method includes printing one or more copies of the print job and determining at least one color registration error for at least one type of color registration error produced during the printing of the one or more copies of the print job. The color registration errors are determined by comparing each color plane to a reference color plane, and the color registration errors can be produced by one or any combination of registration error types: color plane translation, color plane rotation, and color plane stretch or contraction in each of the in-track and cross-track directions. These registration errors can be measured by using an image sensor, which captures an image of test marks printed by the various print stations, as described in U.S. Pat. No. 8,104,861.

In order to provide a digital printing system for non-contact printing onto a continuous web of print media at high transport speeds, the apparatus and method of the present invention apply a number of exact constraint principles to the problem of web handling and web tensioning, including the following:
(a) Employing, over each web span, a pairing of lateral and angular constraints, with the angular constraint downstream of the lateral constraint. Over each web span subsequent to the first web span in the system, the method uses the given lateral position of the web as the given edge-constraint.
(b) Use of zero-constraint castered rollers, non-rotating surfaces, or low wrap angle rollers where it is desirable to guide the print media without constraint. This is the case, for example, where there is an overhang condition, where some length of the web within a web span extends past the angular constraint for that web span.
(c) Use of gimbaled rollers where desirable to provide an angular constraint, taking advantage of the capability of the web to twist without over-constraint. Use of gimbaled only rollers where desirable to provide an angular constraint in the web span immediately upstream while imparting no angular constraint in the web span immediately downstream of that roller.

An active steering mechanism can be used within a web span, such as where the web span length of an overhang exceeds its width resulting in the web no longer having sufficient mechanical stiffness for exact constraint techniques. This can happen, for example, where there is considerable overhang along the web span, that is, length of the web extending beyond the angular constraint for the span. This can be the case for modules 72 and 78 in the aspect described with respect to FIG. 5. In such a case, a castered roller in the overhang section of the web may no longer behave as a zero constraint, since some amount of lateral force from the web is needed in order to align the castered roller mechanism to the angle of the web span. This under-constraint condition, due to length of the overhang along this lengthy web span, is corrected by application of an additional constraint.

Kinematic connection between modules 20 and 40 follows the same basic principles that are used for exact constraint within each web span. That is, cross-track or edge alignment is taken from the preceding module. Any attempt to re-register the print media edge as it enters the next module would cause an over-constraint condition. Rather than attempting to steer the continuously moving print media through a rigid and over-constrained transport system, the print media transport components of the present invention self-align to the print media, thereby permitting effective registration at high transport speeds and reducing the likelihood of damage to the print media or mis-registration of applied ink or other colorant to the print media.

Where multiple print stations are used within a module, as described with reference to the aspect shown in FIG. 5, it is desirable that the system have a master drive roller that can control the web transport speed through the multiple print stations. Multiple drive rollers can be used and can help to provide proper tension in the web transport (in-track) direction, such as by applying suitable levels of torque, for example. According to an aspect of the present invention, the turnbar (TB) module drive roller 32 can act as the master drive roller. The infeed drive roller at B in module 20 can adjust its torque according to a load sensing mechanism or load cell that senses web tension between the master drive and infeed rollers. Similarly, outfeed drive roller N can be controlled in order to maintain a desired web tension within second module 40.

It can be seen that the method of the present invention can be applied for handling continuous web of print media transport within and between one, two, three, or more print stations within a module, applying exact constraint techniques. This flexibility permits a web transport arrangement that provides effective registration and repeatable performance at high speeds commensurate with the requirements of high-speed color inkjet printing. As has been shown, multiple print stations can be integrated into a module, and multiple modules can be integrated to form a printing system, without the requirement for painstaking alignment of rollers or other media handling components within the module or at the interface between two modules.

It has been found that web transport systems as described above maintain effective control of the print media in the context of a digital print system where the selected portions of the print media are moistened in the printing process. This is true even when the print media is prone to expanding in length and width and to becoming less stiff when it is moistened, such as for cellulose based print media moistened by a water based ink. This enables the individual color planes of a multi-colored document to be printed with effective registration to each other.

Similarly, for the manufacture of touch screen panels the solvent based ink can soften the plastic support and lengthen it. A subsequent drying step can dry the solvent based ink, but also distort the plastic support as it is conveyed under tension past the individual printing and drying stations. Controlling the tension to reduce the deformation of the substrate or produce a consistent amount of deformation during the printing process can improve the registration of sequentially deposited image planes.

The digital printing systems having one or more print stations that selectively moisten at least a portion of the print media as described above include a print media transport system that serves as a support structure to guide the continuous web of print media. The support structure includes an edge guide or other mechanism that positions the print media in the cross track direction. This first mechanism is located upstream of the print stations of the digital printing system. The print media is pulled through the digital printing system by a driven roller that is located downstream of the print stations. The systems also include a mechanism located upstream of print stations of the printing system for establishing and setting the tension of the print media. Typically it is also located downstream of the first mechanism used for positioning the print media in the cross track direction. The transport system also includes a third mechanism to set an angular trajectory of the print media. This can be a fixed roller (for example, a non-pivoting roller) or a second edge guide. The printing system also includes a roller affixed to the support structure, the roller configured to align to the print media being guided through the printing system without necessarily being aligned to another roller located upstream or downstream relative to the roller. The castered, gimbaled, or castered and gimbaled rollers serve in this manner.

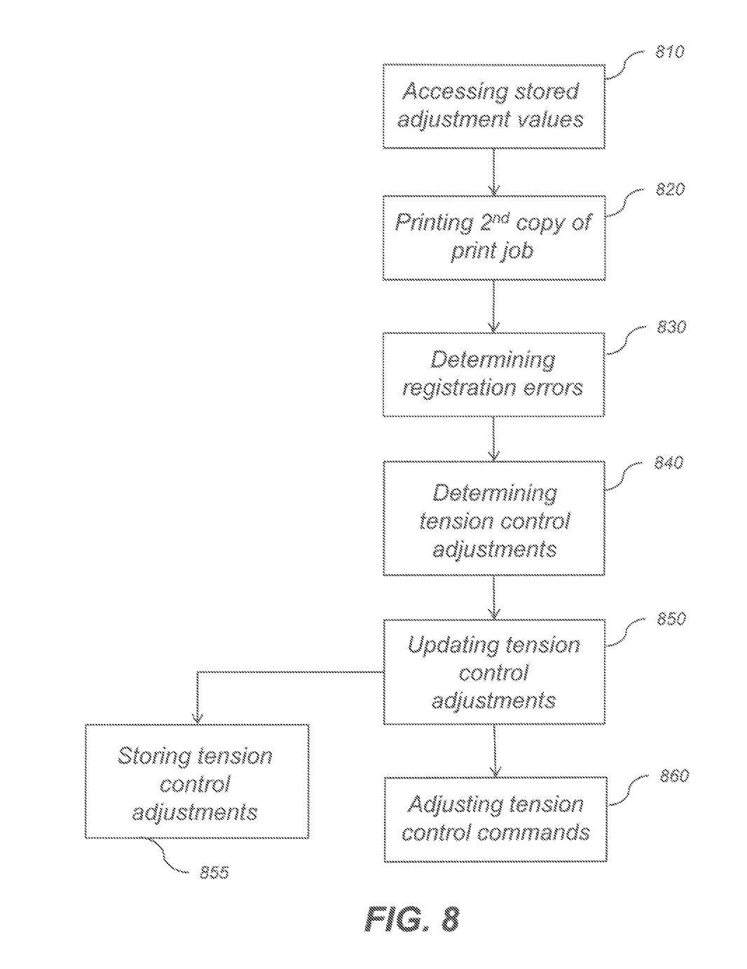

FIG. 7 shows a flowchart for a method for using tension control adjustments to reduce registration errors while printing multiple copies of a print job according to an aspect of the invention. As well known in the art, the steps of the method shown in the flowchart of FIG. 7 can be performed by an external processor or computing device in communication with on-board memory or external storage or by the on-board control logic processor 90 having associated memory or storage. In step 710, a printing system is provided. The printing system has at least one print station disposed opposite a first side of a web, the print station defining one or more print zones where a liquid is deposited onto the first side of the web. The printing system also includes one or more rollers adapted to receive tension control commands. In some aspects of the invention, these rollers can be drive rollers such as the infeed drive roller, the outfeed drive roller, or the turnbar roller.

The tension control commands operate on the rollers to control the amount of tension of print media in the printing system as it moves through the print zone. In Step 720, a first copy of the print job is printed using the print stations in the printing system. In Step 730, a plurality of registration errors produced during the printing of the first copy of the print job is determined. In Step 740, first tension control adjustments are determined based on the plurality of registration errors. In Step 745, the first tension control adjustments are stored in processor-accessible memory for printing subsequent print jobs. In Step 750, the first tension control adjustments are used to adjust the tension control commands to the one or more rollers in the printing system. In Step 760, a second copy of the print job is printed using the printing system.

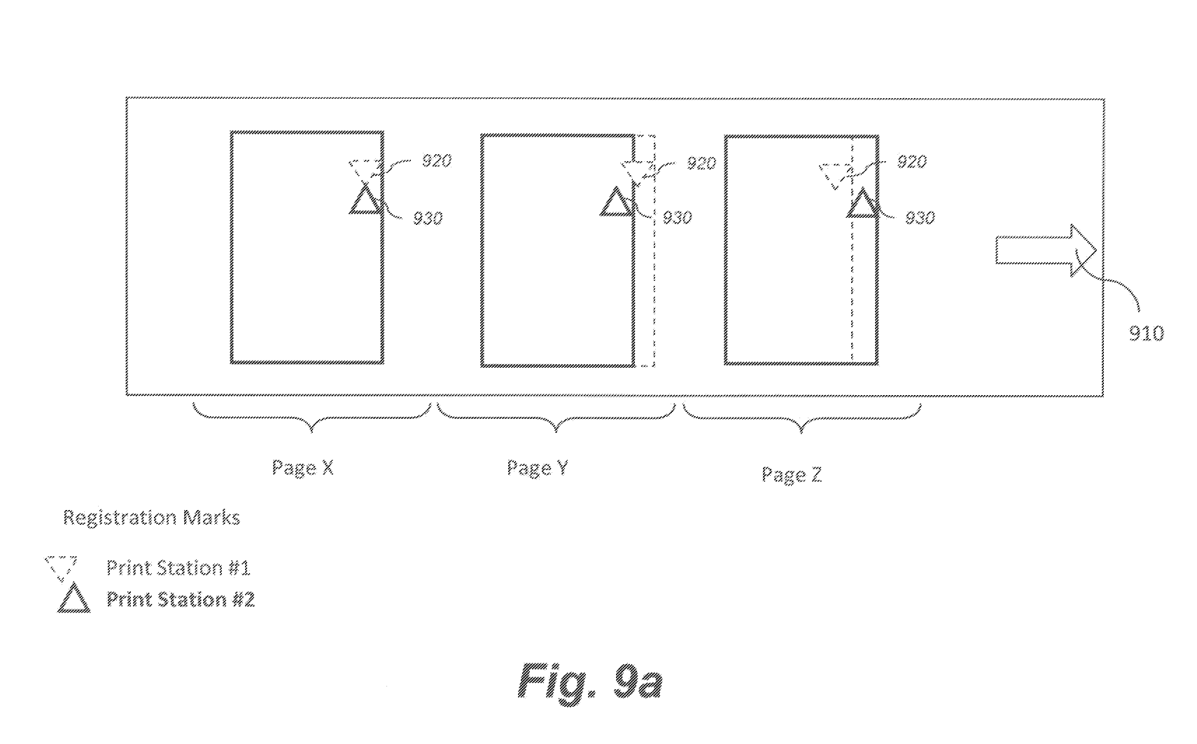

FIG. 8 shows a flowchart for a method for printing according to another aspect of the present invention. In Step 810, the stored first tension control adjustments are accessed from the processor-accessible memory or storage device. In Step 820, a second copy of the print job is printed using the stored first tension control adjustments to adjust the tension control commands sent to the one or more rollers in the printing system. In Step 830, at least one registration error produced during the printing of the second copy of the print job is determined. In Step 840, second tension control adjustments for each registration error produced during the printing of the second copy of the print job are computed. In Step 850, the stored tension control adjustments are updated using the respective second tension control adjustments associated with the printing of the second copy of the print job. This can be done using mathematical techniques well known in the art such as averaging the first and second tension control adjustments to produce updated tension control adjustments. Alternately, the second tension control adjustments can replace the stored tension control adjustments. The first and second tension control adjustments can be weighted differently to assign preference to one or the other. For example, the first stored tension control adjustments can be given 25% weight and the second tension control adjustments can be given 75% weight. This permits the system to rely more on the newest computed adjustments but reduces the likelihood of rapidly switching back and forth between different tension control adjustments determined from printing multiple copies of the print job.

In Step 855, the updated tension control adjustments are stored in processor-accessible memory for printing subsequent print jobs. In Step 860, the updated stored tension control adjustments are used to adjust the tension control commands to the first one or more rollers in the printing system when printing a subsequent copy of the print job. The steps of the method shown in FIGS. 7 and 8 can be performed periodically or non-periodically to update each stored tension control adjustment when printing multiple or subsequent copies of the print job.

In another aspect of the present invention, the first tension control adjustments can also be determined based on an ink load printed on the print media, in combination with the determined registration errors. Higher ink load produced by laydown of more ink on the web can produce more expansion of the print media than a lower ink load.

According to another aspect of the invention, the printing system can include second one or more rollers with load cells. These rollers are the same as one or more of the first rollers adapted to receive tension control commands, or a different set of rollers. The load cells are used to measure the tension in the printing system in one or more print zones defined by the print stations. The second one or more rollers are high wrap rollers where the wrap angle subtended by the portion of the print media in contact with the roller is greater than 75 degrees and, preferably, greater than 90 degrees.

According to another aspect of the invention, the first tension control adjustments are determined as profile for each page in the print job. In this aspect, an individual tension adjustment value is determined for each page in the print job. A profile of the individual tension adjustment values for all the pages in the print job can then be produced and used to determine the first tension control adjustments. This profile can be a discrete set of numbers for each page. Well known mathematical functions can also be used to “smooth” the profile to reduce abrupt changes in tension in the print media.

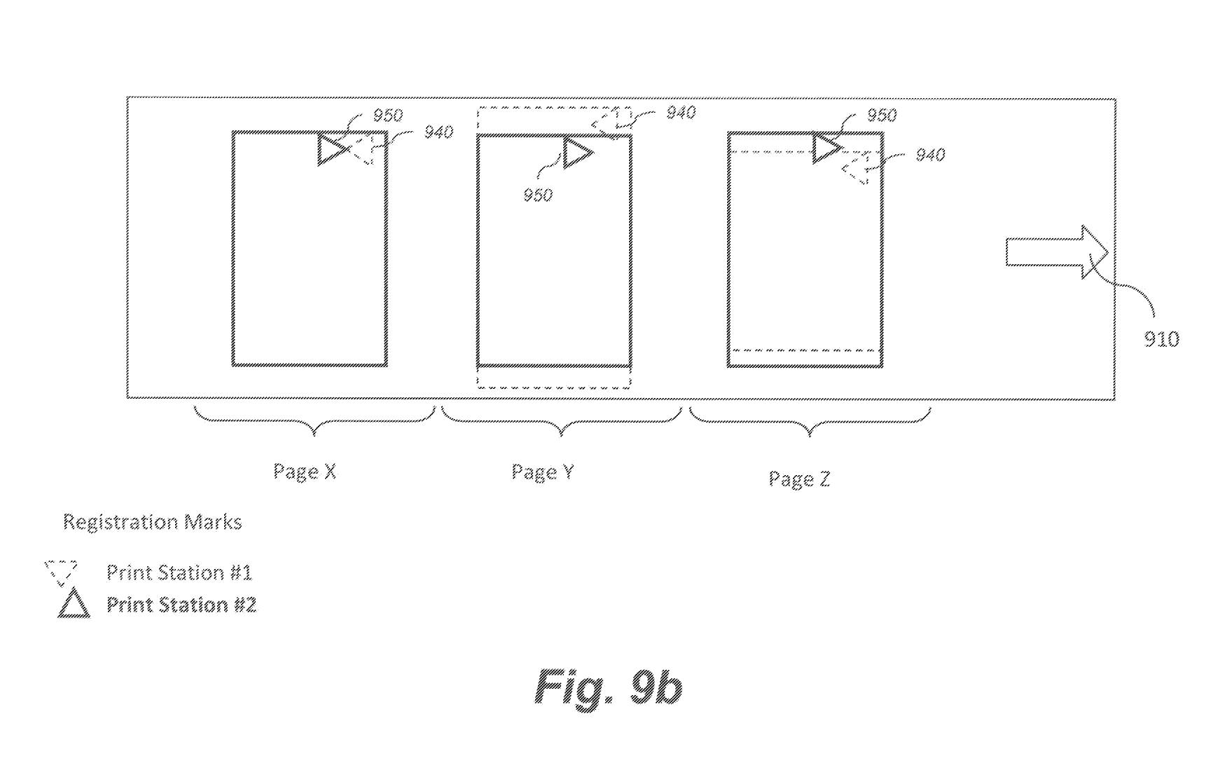

According to one aspect of the present invention, the tension control adjustments are based on the registration errors. A higher tension correction signal is computed to correct for a registration error corresponding to a lower tension measurement in the printing system. A lower tension correction signal is computed to correct for a registration error corresponding to a higher tension measurement in the printing system. Each printing station in the printing system can print registration marks on the print media. FIG. 9a shows examples of registration marks 920 and 930 printed on the print media by two print stations on three different pages of the print job. These marks correspond to registration errors in the in-track direction due to expansion or contraction of the web in the in-track direction. Arrow 910 indicates the direction of web movement through the printing system.

As shown on page X, the registration mark 920 printed by the first print station and the registration mark 930 printed by the second print station are aligned with respect to each other, implying that the web is in a steady tension state and the print media is appropriately aligned with the printheads in the print zones. In this case, no adjustments to the steady tension state are required. On page Y, the registration mark 920 printed by print station 1 is to the right of the registration mark 930 printed by print station 2. This corresponds to an expansion of a portion of the web corresponding to page Y between print station 1 and print station 2. The edge of expanded page Y as it passes through print station 2 is shown as the dashed line. This expansion of the web results in a lower tension in the web causing a mis-alignment of the web between print stations 1 and 2. To reduce the registration error, the tension control adjustment value for page Y is set to a higher value than the normal value. This translates into tension control commands for the first rollers to increase the tension in the web of print media in the print zone of print station 2, thus reducing the misalignment distance between the two registration marks. Since the tension is achieved by a differential speed between the infeed drive roller and the drive roller in the turnbar, the speed of the infeed drive roller is slightly decreased with respect to the drive roller in the turnbar to increase the tension in the print zone. The tension control adjustment values can be computed using well known mathematical methods. As an example, a look-up-table can be produced for tension control adjustment values based on the measured distance between the marks. A smaller distance between registration marks requires a smaller adjustment value than a larger distance between registration marks. Instead of a look-up-table, the above relationship can also be represented using a function of distance versus adjustment value.

On page Z, the registration mark 920 printed by print station 1 is to the left of the registration mark 930 printed by print station 2. This corresponds to a contraction of a portion of the web corresponding to page Z between print station 1 and print station 2, resulting in a higher tension in the print media. The edge of contracted page Z as it passes through print station 2 is shown as the dashed line. To reduce the registration error, the tension control adjustment value for page Z is set to a lower value than the normal value. This translates into tension control commands for the first rollers to decrease the tension on the web of print media in the print zone of print station 2, thus reducing the misalignment distance between the two registration marks. Since the tension is achieved by a differential speed between the infeed drive roller and the drive roller in the turnbar, the speed of the infeed drive roller is slightly increased with respect to the drive roller in the turnbar to decrease the tension in the print zone.

FIG. 9b shows examples of registration marks 940 and 950 printed on the print media by two print stations on three different pages of the print job. These marks correspond to registration errors in the cross-track direction due to expansion or contraction of the web in the cross-track direction. Arrow 910 indicates the direction of web movement through the printing system.

As shown on page X, the registration marks 940 and 950 printed by the first and second print stations are aligned with respect to each other, implying that the web is in a steady tension state and the alignment of the print zones to each other corresponds to the cross-track placement of the web of print media travelling between the print stations. In this case, no adjustments to the steady tension state are required. On page Y, the registration mark 940 printed by print station 1 is outside of the registration mark 950 printed by print station 2. This corresponds to an expansion of a portion of the web corresponding to page Y, as shown by the dashed line, between print station 1 and print station 2 in the cross-track direction. This expansion of the web results in a lower tension in the web. To reduce the registration error, the tension control adjustment value for page Y is set to a higher value than the normal value. This translates into tension control commands for the first rollers to increase the tension on the web of print media in the print zone of print station 2, reducing the misalignment distance between the two registration marks by stretching the print media in the in-track direction to reduce its cross-track expansion. Since the tension is achieved by a differential speed between the infeed drive roller and the drive roller in the turnbar, the speed of the infeed drive roller is slightly decreased with respect to the drive roller in the turnbar to increase the tension in the print zone. The tension control adjustment values can be computed using well known mathematical methods. As an example, a look-up-table can be produced for tension control adjustment values based on the measured distance between the marks. A smaller distance between registration marks requires a smaller adjustment value than a larger distance between registration marks. Instead of a look-up-table, the above relationship can also be represented using a function of distance versus adjustment value.

On page Z, the registration mark 940 printed by print station 1 is on the inside of the registration mark 950 printed by print station 2. This corresponds to a contraction of a portion of the web corresponding to page Z, as shown by the dashed line, between print station 1 and print station 2 in the cross-track direction, resulting in a higher tension in the web of print media. To reduce the registration error, the tension control adjustment value for page Z is set to a lower value than the normal value. This translates into tension control commands for the first rollers to decrease the tension on the web of print media in the print zone of print station 2, thus reducing the misalignment distance between the two registration marks by reducing the tension in the in-track direction to increase its cross-track expansion. Since the tension is achieved by a differential speed between the infeed drive roller and the drive roller in the turnbar, the speed of the infeed drive roller is slightly increased with respect to the drive roller in the turnbar to decrease the tension in the print zone.

FIGS. 9a and 9b show simplified versions of the registration errors corresponding to dimensional changes of portions of the web only in the in-track or cross-track directions respectively. The dimensional changes of the print media can occur in both the cross-track and the in-track direction simultaneously. These dimensional changes in cross-track and in-track direction are, in general, non isotropic: for one, the print media is conveyed past the various print stations under tension applied by the web transport in the in-track direction, for another, the support can be manufactured intentionally anisotropic (for example pre-tensilized PET) to counteract the tension applied by the conveyance system during printing. The registration marks printed by print station 1 and print station 2 can be offset from each other by both an in-track separation and a cross-track separation. The tension control adjustments can be computed to account for both of these registration errors at the same time or separately.

In some aspects of the invention, the print media is paper or other substrate where the printing system prints the print job using color separations. In these aspects, the registration errors are color-to-color registration errors between the color separations printed by the printing stations. In other aspects of the present invention, the print media is a substrate for a multi-layered electrical circuit where the printing system prints the print job using conductive, insulating, or protective separations. In these aspects, the registration errors are alignment errors between the printed separations. Also, in the case of printed multi-layer electrical circuits, the jetting modules in each print station jet only electrically conductive inks, electrically insulating inks or inks to form protective coatings for the electrical circuit.

In another aspect of the invention, a system for using tension control adjustments to reduce registration errors while printing multiple copies of a print job can comprise a printing system, a sensor, and a processor. The printing system can include one or more print stations disposed opposite a first side of a web. The print stations define one or more print zones where a liquid is deposited onto the first side of the web. The printing system can also include first one or more rollers adapted to receive tension control commands, the tension control commands operating on the first rollers to control the amount of tension of print media in the printing system. The printing system is used to print a first, a second, or a subsequent copy of the print job.

The sensor is used to determine a plurality of registration errors produced during the printing of the first, second, or subsequent copy of the print job. In one aspect of this invention, the sensor is a camera that can record images of registration marks printed by the printing stations on the web. Well known computer vision techniques can be used to compute the distance between the printed registration marks to determine the registration error using the processor. The processor can also be used to determine first tension control adjustments based on the plurality of registration errors and to use the first tension control adjustments to adjust the tension control commands to the one or more first rollers in the printing system. When printing a second copy of the print job, the tension control commands modify the tension in the print zones, thereby reducing registration errors.

In another aspect of the invention, the processor is used to periodically or non-periodically update each stored tension control adjustment associated with the printing of subsequent copies of the print job. Second tension control adjustments for each registration error produced during the printing of the second or subsequent copy of the print job are determined. The stored tension control adjustments are updated using the respective second tension control adjustments associated with the printing of the second or subsequent copy of the print job. The tension control commands to the first one or more rollers are adjusted, based on the updated tension control adjustments, when printing a subsequent copy of the print job reduce registration errors.

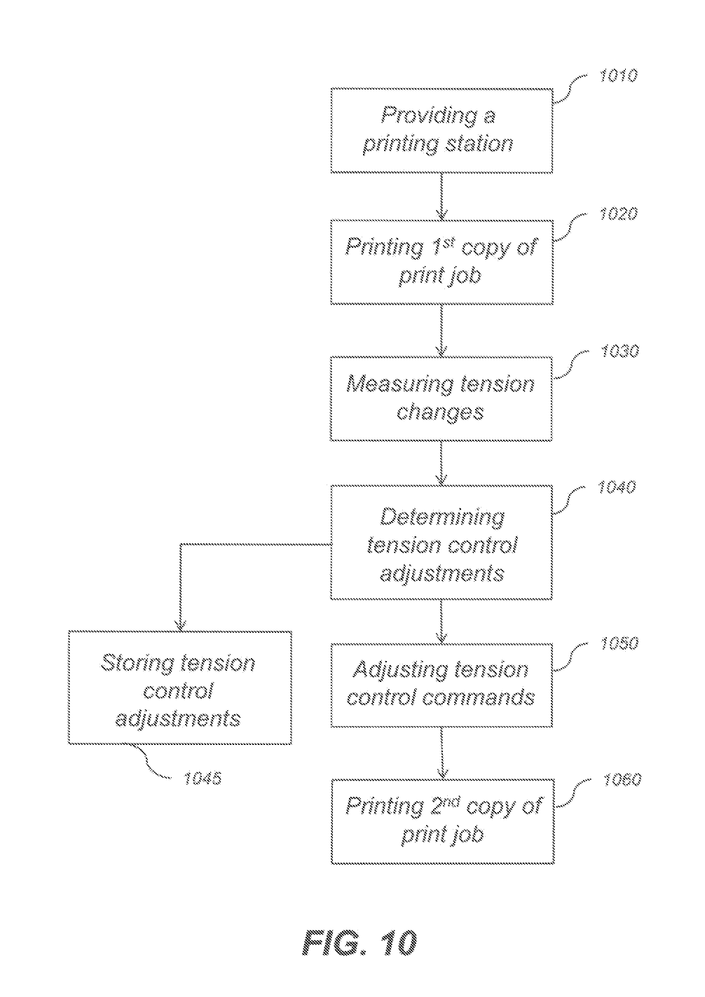

FIG. 10 shows a method for reducing tension fluctuations while printing multiple copies of a print job according to another aspect of the invention. As well known in the art, the steps of the method shown in the flowchart of FIG. 10 can be performed by an external processor or computing device in communication with on-board memory or external storage or by the on-board control logic processor 90 having associated memory or storage, in the printing system. In step 1010, a printing system is provided. The printing system has at least one print station disposed opposite a first side of a web, the print station defining one or more print zones where a liquid is deposited onto the first side of the web. The printing system also includes one or more rollers adapted to receive tension control commands. In some aspects of the invention, these rollers are drive rollers such as the infeed drive roller, the outfeed drive roller, or the turnbar roller.

The tension control commands operate on the rollers to control the amount of tension of print media in the printing system as it moves through the print zone. In Step 1020, a first copy of the print job is printed using the print stations in the printing system. In Step 1030, tension changes produced during the printing of the first copy of the print job are measured. In Step 1040, first tension control adjustments are determined based on the measured tension changes. In Step 1045, the first tension control adjustments are stored in processor-accessible memory for printing subsequent print jobs. In Step 1050, the first tension control adjustments are used to adjust the tension control commands to the one or more rollers in the printing system. In Step 1060, a second copy of the print job is printed using the printing system.

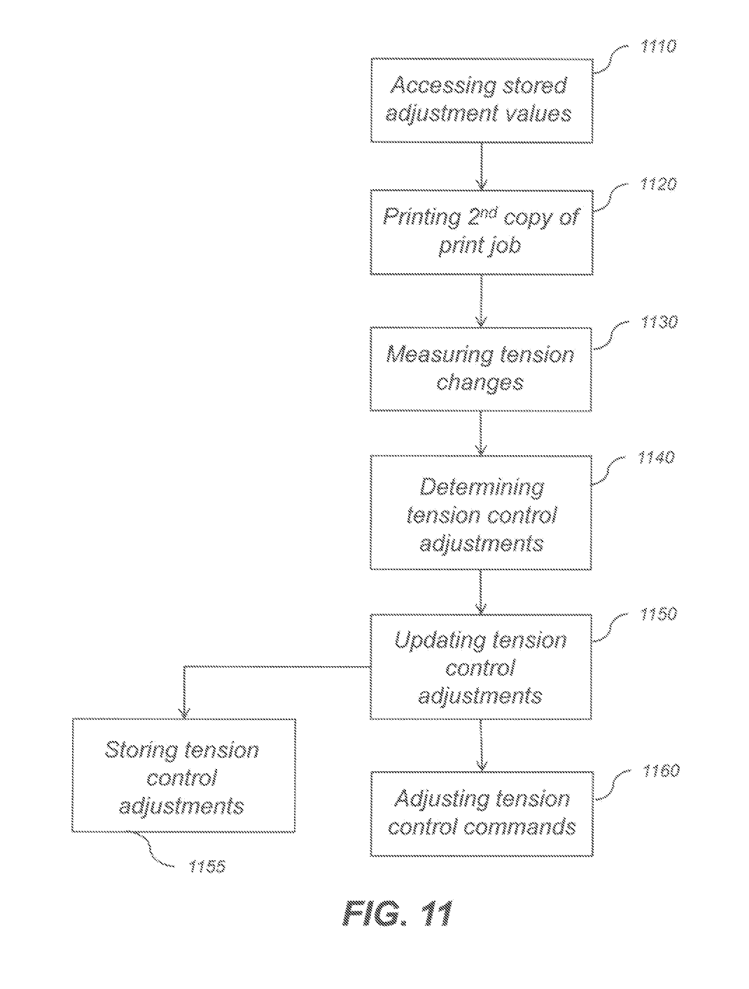

FIG. 11 shows a flowchart for a method for printing according to another aspect of the present invention. In Step 1110, the stored first tension control adjustments are accessed from the processor-accessible memory or storage device. In Step 1120, a second copy of the print job using the stored first tension control adjustments to adjust the tension control commands sent to the one or more rollers in the printing system. In Step 1130, tension changes produced during the printing of the second copy of the print job are measured. In Step 1140, second tension control adjustments for each registration error produced during the printing of the second copy of the print job are computed. In Step 1150, the stored tension control adjustments are updated using the respective second tension control adjustments associated with the printing of the second copy of the print job. This can be done using mathematical techniques well known in the art such as averaging the first and second tension control adjustments to produce updated tension control adjustments. The first and second tension control adjustments can be weighted differently to assign preference to one or the other. For example, the first stored tension control adjustments can be given 25% weight and the second tension control adjustments can be given 75% weight. This permits the system to rely more on the newest computed adjustments but reduces the likelihood of rapidly switching back and forth between different tension control adjustments determined from printing multiple copies of the print job.

In Step 1155, the updated tension control adjustments are stored in processor-accessible memory for printing subsequent print jobs. In Step 1160, the updated stored tension control adjustments are used to adjust the tension control commands to the first one or more rollers in the printing system when printing a subsequent copy of the print job. The steps of the method shown in FIGS. 10 and 11 are performed periodically or non-periodically to update each stored tension control adjustment when printing multiple or subsequent copies of the print job.

In these aspects of the invention, controlling the tension in the print media at a steady state is desirable for ensuring proper registration of separations printed by the print stations on the web. The web undergoes wetting and drying in the printing system, which can result in expansion or contraction of the web. In one aspect of the present invention, the registration errors from the expansion and contraction of the web can be reduced by digital alteration of the printed separations to account for the deformations in the web. Changes in the tension of the web can negatively impact this digital correction. Changes in the tension in the web can also cause the formation of folds or wrinkles in the web of print media. The method of FIGS. 10 and 11 provide significant advantage in reducing tension fluctuations in the web and maintaining it at a steady state for printing multiple separations and aligning them properly. Controlling the tension in the web can also reduce the formation of folds or wrinkles in the web due to deformations from wetting and drying of the web.

In these aspects of the invention, a higher tension correction signal is computed to correct for a lower tension measurement in the printing system. Similarly, a lower tension correction signal is computed to correct for a higher tension measurement in the printing system.

According to another aspect of the invention, a system for reducing tension fluctuations while printing multiple copies of a print job includes a printing system, a sensor, and a processor. The printing system includes one or print stations disposed opposite a first side of a web, the print station defining one or more print zones where a liquid is deposited onto the first side of the web. The printing system also includes first one or more rollers adapted to receive tension control commands, the tension control commands operating on the first rollers to control the amount of tension of print media in the printing system.

The sensor, such as load cells on the first rollers or on separate second rollers, measures tension changes produced in the print zone defined by the print station during the printing of the print job. The processor is responsive to the sensor and determines first tension control adjustments based on the measured tension changes. The processor can also determine the first tension control adjustments to adjust the tension control commands to the one or more first rollers in the printing system when printing a second or subsequent copy of the print job, thereby reducing tension fluctuations.

The invention has been described in detail with particular reference to certain preferred embodiments thereof, but it will be understood that variations and modifications can be effected within the scope of the invention.

### PARTS LIST

10. Printing system
12. Source roller
14. Dryer
16. Print station
18. Take-up roll
20. Print station module
22. Cross-track positioning mechanism
24. Tensioning mechanism
26. Constraint structure
30. Turnbar module
32. Drive roller
34, 36. Turnbar roller
40. Print station module
48. Support structure
50. Printing system
52. Slack loop
54. Print zone
70. Entrance module
72. Print station module
74. End feed module
76. Forward feed module
78. Print station module
80. Outfeed module
90. Control logic processor
110. Input Equipment
120. Output Equipment
710. Step of providing printing station
720. Step of printing first copy of print job
730. Step of determining registration errors
740. Step of determining tension control adjustments
745. Step of storing tension control adjustments
750. Step of adjusting tension control commands
760. Step of printing second copy of print job
810. Step of accessing stored tension control adjustments
820. Step of printing second copy of print job
830. Step of determining registration errors
840. Step of determining tension control adjustments
850. Step of updating tension control adjustments
855. Step of storing tension control adjustments
860. Step of adjusting tension control commands
910. Arrow indicating direction of web transport
920. Registration mark
930. Registration mark
940. Registration mark
950. Registration mark
1010. Step of providing printing station
1020. Step of printing first copy of print job
1030. Step of measuring tension changes
1040. Step of determining tension control adjustments
1045. Step of storing tension control adjustments
1050. Step of adjusting tension control commands
1060. Step of printing second copy of print job
1110. Step of accessing stored tension control adjustments
1120. Step of printing second copy of print job
1130. Step of measuring tension changes
1140. Step of determining tension control adjustments
1150. Step of updating tension control adjustments
1155. Step of storing tension control adjustments
1160. Step of adjusting tension control commands
A. Edge guide
B, C, D, E, F, G, H, I, J, K, L, M, N, O, P. Rollers,
SW. S-wrap
TB. Turnbar module

1. A method for using tension control adjustments on a web to reduce registration errors while printing multiple copies of a print job on the web, comprising:
providing a printing system with a print station disposed opposite a first side of the web, the print station defining one or more print zones where a liquid is deposited onto the first side of the web, and first one or more rollers adapted to receive tension control commands, the tension control commands operating on the first one or more rollers to control an amount of tension of the web in the printing system;
using the printing system to print a first copy of the print job on the web;
determining a plurality of registration errors produced during a printing of the first copy of the print job;
using a processor to determine first tension control adjustments based on the plurality of registration errors by:
determining an individual tension adjustment value for each nacre in the print job;
producing a profile of the individual tension adjustment values for all the pages in the print job; and
using the produced profile to determine the first tension control adjustments; and
using the first tension control adjustments to adjust the tension control commands to the first one or more rollers in the printing system for printing a second copy of the print job, thereby reducing registration errors.

2. The method according to claim 1, further including storing the first tension control adjustments in processor-accessible memory for printing subsequent print jobs.

3. The method according to claim 2, further including:
using the printing system to print a second copy of the print job using the stored first tension control adjustments;
determining at least one registration error produced during a printing of the second copy of the print job;
using the processor to determine second tension control adjustments for each registration error produced during the printing of the second copy of the print job and to update each stored tension control adjustments using respective second tension control adjustments associated with the printing of the second copy of the print job; and
using updated stored tension control adjustments to adjust the tension control commands to the first one or more rollers in the printing system when printing a subsequent copy of the print job, thereby reducing registration errors.

4. The method according to claim 3, further including storing updated tension control adjustments in processor-accessible memory for printing subsequent print jobs.

5. The method according to claim 3, further including updating each stored tension control adjustment associated with a printing of subsequent copies of the print job.

6. The method according to claim 1, wherein determining the first tension control adjustments further includes determining the first tension control adjustments based on an ink load printed on the web.

7. The method according to claim 1, wherein the printing system further includes second one or more rollers in contact with the web, and wherein using a processor to determine first tension control adjustments further includes:
measuring tension in the printing system using load cells located on the second one or more rollers; and
computing a higher tension correction signal to correct for a registration error corresponding to a lower tension measurement in the printing system or computing a lower tension correction signal to correct for a registration error corresponding to a higher tension measurement in the printing system.

8. The method according to claim 7, wherein the second one or more rollers are fixed rollers with high wrap angle.

9. (canceled)

10. The method according to claim 1, wherein the web is paper, wherein the printing system prints the print job using color separations, and wherein the registration errors are color-to-color registration errors.

11. The method according to claim 1, wherein the web is a substrate for a multi-layered electrical circuit, wherein the printing system prints the print job using conductive, insulating, or protective separations, and wherein the registration errors are alignment errors between the printed separations.

12. The method according to claim 11, wherein the jetting modules in each print station jet only electrically conductive inks, electrically insulating inks or inks to form protective coatings for the electrical circuit.

13. The method according to claim 1, wherein the first one or more rollers are drive rollers for the web.

14. The method according to claim 13, wherein the drive rollers include an infeed drive roller, an outfeed drive roller, or a turnbar roller.
